(19) United States
(12) Patent Application Publication
(10) Pub. No.: US 2022/0121962 A1
(43) Pub. Date: Apr. 21, 2022

(54) BlockNet security organization storage mapping method for spatial data

(71) Applicant: Qingdao University, Qingdao (CN)

(72) Inventors: Zhihan Lv, Qingdao (CN); Liang Qiao, Qingdao (CN); Jinhua Li, Qingdao (CN)

(21) Appl. No.: 17/566,615

(22) Filed: Dec. 30, 2021

(30) Foreign Application Priority Data
Nov. 1, 2021 (CN) 202110031642.8

(51) Int. Cl. G06N 3/12; G06V 10/22; G06V 10/74; G06T 17/05; G06T 19/00; H04L 9/32

(52) U.S. Cl. CPC G06N 3/126; G06V 10/23; G06V 10/761; H04L 2209/38; G06T 19/003; G06T 19/006; H04L 9/3236; G06T 17/05

(57) ABSTRACT

A BlockNet security organization storage mapping method for spatial data includes: first constructing a BlockNet gene propagation mechanism according to the characteristics of the BlockNet storage space data, and then designing multi-source gene propagation in a multi-space data center scenario mechanism. In the multi-source gene propagation mechanism, the propagation round control and the in/out-degree control mechanism are designed for the possible radiation crossover problems and radiation impact problems. A BlockNet information update plan is designed for data modification and update requirements in spatial data storage scenarios. In addition to realizing the unique primary key block coding of spatial data and accelerating the indexing speed, it also retains elevation information through multi-dimensional coding, expands the amount of information, improves the utilization efficiency of spatial data, and the security of data mapping and storage process is greatly improved.

### CROSS REFERENCE OF RELATED APPLICATION

The present invention claims priority under 35 U.S.C. 119(a-d) to CN 202110031642.8, filed Jan. 11, 2021.

### BACKGROUND OF THE PRESENT INVENTION

### Field of Invention

The present invention relates to a technical field of BlockNet, in particular to a storage and mapping method for spatial data-oriented BlockNet security organization.

### Description of Related Arts

In recent years, with the development of computer virtual reality technology and the improvement of data extraction and analysis capabilities, people have paid more and more attention to the research of virtual reality simulation of real scenes, and they are extracting real world information according to geographic blocks and mapping it to the virtual world. The process is cross-domain, and data interpretation errors and data tampering may occur during this process. Blockchain technology is often used in data security storage scenarios because of its decentralized, unmodifiable, traceable and other characteristics. It has already achieved good applications in credit investigation, finance, and traceability, and has changed the lives of the people. The division and indexing of spatial three-dimensional structure data is a key application scenario of blockchain technology.

Geographic location is generally used to describe the temporal and spatial relationships of geographic things. From the universe to the cell, there are geographic attributes. How to effectively divide the geographic location of reality-virtual mapping and build a model for it is a difficult problem. Secondly, with the development of 5G mobile communication and Internet of Things technologies, in order to adapt to the mainstream storage methods of next-generation cloud computing and distributed integration, data collection will be biased towards decentralization. At that time, point-to-point data storage and consensus mechanisms will break the conventional data oligopoly, it is necessary to ensure the safety and accuracy of multi-dimensional data in the process of mapping to virtual space, and build a reliable data organization mapping model for multi-dimensional data. In this process, the problem that needs to be solved is: how to organize and store the complex and large amount of three-dimensional geographic data including latitude, longitude and height, and realize the division of geographic data with different granularity from macro to micro, to build a unique multi-level And multi-granularity data structure, realize the data mapping from real space to virtual space, and strictly guarantee data security.

### SUMMARY OF THE PRESENT INVENTION

Aiming at the defects of the prior art, the present invention provides a spatial data-oriented BlockNet security organization storage mapping method, which solves the defects in the prior art.

In order to achieve the above purpose of the present invention, the technical solutions adopted by the present invention are as follows:

a space data-oriented BlockNet security organization storage mapping method, comprising:

first, building a BlockNet gene propagation mechanism based on characteristics of BlockNet storage space data, and then designing a multi-source gene propagation mechanism for multi-space data center scenarios; wherein in the multi-source gene propagation mechanism, the propagation round control and the in-out-degree control mechanisms are designed for possible radiation crossover problems and radiation impact problems; designing a BlockNet information update plan for data modification and update requirements in spatial data storage scenarios, and providing data retrieval methods from two perspectives of chain search and row and column index for spatial data utilization scenarios.

For partition index of three-dimensional spatial data, elevation data is added to original two-dimensional Hash geocoding, and a data index conversion is adapted to multi-level division. A three-dimensional logical distance calculation algorithm is used to determine a three-dimensional logical distance. Latitude and longitude code and elevation code of target blocks are XORed, and then results of two XOR operations are calculated by an Euclidean distance to obtain the three-dimensional logical distance.

Aiming at a multi-center situation that may occur in a process of mapping spherical data to three-dimensional data, a spherical multi-source translation projection method is used to first map the spherical data to a three-dimensional space with a random starting point, find a spatial geometric center of a multi-target point, and perform a three-dimensional data translation conversion, so that a three-dimensional spatial data center is aligned with the spatial geometric center.

Further, building the BlockNet gene propagation mechanism based on the characteristics of the BlockNet storage space data comprises specific steps of:

by comparing the problems existing in the application of conventional blockchain technology to 3D Hash geocoding, the particularity of the spatial data organization and mapping process is analyzed; different from the linear storage scheme of the blockchain, a non-stretchable and deformable block storage scheme for two-dimensional data is proposed:

Step 1.1: selecting a starting node of BlockNet construction according to importance of the spatial data; and

Step 1.2: performing Hash encoding propagation on nodes in a quad-connecting area, wherein a next node performs SHA256 calculation on a set of nodes pointing thereto to obtain a Hash value of the nodes pointing thereto.

In order to realize the whole network spread from center to edge, and finally build the BlockNet data storage model. Application scenarios specific to virtual reality comprise specific steps of:

Step 2.1: performing multi-scale division and coding of scene data based on 3D Hash geocoding;

Step 2.2: selecting a center point according to a key area in the spatial data; and

Step 2.3: using spherical translation projection to translate a spatial position and starting BlockNet storage construction from the selected center point.

Different from the blockchain propagation synchronization mechanism, the present invention avoids the repeated update paradox caused by the two-way hash propagation mechanism, proves the one-way propagation principle, and establishes the gene propagation mechanism. It is proposed to select the concept of source block for radiation propagation test, so as to explore the propagation rules in different scenarios and establish the propagation standard applied to the combination of 3D hash geocoding. Analyze the out and in-degree of blocks, study the relationship between security and logical distance of source blocks, and explore the solution of edge block security. Because the block needs to calculate the hash value of the block pointing to it, in the process of BlockNet construction, two-way propagation cannot be carried out between the two blocks, so each block propagates in the opposite direction of the central block, so as to realize the construction of BlockNet. After the BlockNet is constructed, a safety factor is calculated according to a quantity of propagation rounds of each node, so as to evaluate overall security of a model.

Further, in the multi-source gene propagation mechanism, designing the propagation round control and in-out-degree control mechanism for the possible radiation crossover problems and the radiation impact problems is as follows.

In the construction of a single-source BlockNet, if the distance between the two key areas is too far, it will lead to insufficient safety indicators in a certain area. A multi-source block solution is proposed for the multi-center BlockNet, and the risk of radiation propagation in the multi-center block is predicted and carried out. Effectively avoid, research and solve the problem of radiation flow crossover in multi-source blocks, and establish multi-source block radiation propagation rules to effectively prevent the paradox of repeated updates. In the actual network construction, due to network propagation and hardware limitations, the radiation propagation speed will also be different, and there may be a risk of radiation impact, which may cause a certain source block to be impacted. Therefore, the concept of the quantity of propagation rounds is proposed to limit the propagation speed to ensure that each central area The safety factor is stable, and a safety factor evaluation mechanism is established accordingly to achieve objective indicators of the security of the BlockNet.

When there are multiple central points that need important description in a space scene, it is necessary to select multiple source blocks for propagation, and use the quantity of the propagation rounds to control a propagation speed of each source block to maintain synchronization, that is, during the construction of the BlockNet, there is a global variable that controls the quantity of the propagation rounds. The global variable is compared during each round of propagation, and the block number belongs to that round before the propagation continues. Similarly, by counting the quantity of the propagation rounds that each block belongs to, calculate a global safety factor of the BlockNet.

For the quad-connecting neighborhoods of each block, the amount of access status markers is designed to represent the inheritance relationship between the nodes in their corresponding directions. In the propagation and construction stage of the BlockNet, the in-out-degree control mechanism comprises steps of:

Step 3.1: for all blocks, initializing in-out-degree status flags of a quad-connecting neighborhood to in-degree;

Step 3.2: when a block triggers a propagation operation, checking an access status of a quad-connecting neighborhood block to it; if it is out, executing a Step 3.3; otherwise, executing a Step 3.4;

Step 3.3: stopping propagation in this direction and setting an access status flag in a corresponding direction to an in-degree;

Step 3.4: marking the access status of the corresponding direction as out, and putting a corresponding direction node into a next round of a propagation list, and performing the Step 3.2.

Furthermore, mutual search and data retrieval among multiple data nodes are realized. In this process, the model needs to be able to map the position of the three-dimensional spherical model and the global geographic regional spatial data node network at the same time, divide and index them uniformly, and integrate the advantages of the spatial division methods in the three fields.

For spatial data utilization scenarios, the retrieval process is carried out in two ways: chain search and row column index. When preloading the resource sharing of adjacent scenes, the following steps need to be taken:

Step 4.1: for a data demand node, broadcasting a row and column index corresponding to a current scene position to neighboring nodes;

Step 4.1: for adjacent nodes, finding a BlockNet location of a current scene resource through the row and column index;

Step 4.2: traversing quad direction nodes in block information of the current location, obtaining and loading data of these nodes, so as to realize the chain search; and

Step 4.3: sending corresponding scene resources to the data demand node.

Further, the 3D logical distance calculation algorithm of the 3D hash geocoding design is as follows:

aiming at shortcomings of conventional Hash geocoding technology in organization of multi-dimensional geographic information, starting from needs of spatial data collection and sorting, the division characteristics of spatial data are analyzed in depth. By comparing and analyzing the advantages and disadvantages of spatial information data and Hash geocoding, a three-dimensional space including longitude, latitude, and height is divided and a data model is constructed to realize the spatial data. The spatial data is divided into a multi-layer hexadecimal tree according to the longitude and latitude observation plane, and a corresponding code is added to each node at each layer, until a leaf node is divided into a smallest unit of granularity representing the spatial data, wherein a full hexadecimal index tree of the spatial data is constructed, and each leaf node represents a smallest latitude and longitude observation plane. A division unit stores different levels of elevation information in a vertical direction, and then three-digit hexadecimal encoding is performed on the elevation information to generate vertical codes and latitude and longitude codes to form a three-dimensional Hash geocoding. Among them, a space division method can realize unlimited gradient division from macro to micro, so as to be more suitable for multi-dimensional and multi-level spatial data storage in blocks, and explore a logical distance judgment method based on the 3D Hash geocoding. When judging a 3D spatial distance, first different prefix latitude and longitude codes of two 3D Hash geocoding is performed or a plane distance is calculated, then XOR of a suffix elevation code is calculated to get the vertical distance, and finally a spatial Euclidean distance is calculated by calculating the plane distance and the vertical distance.

Further, a BlockNet data modification update method comprises steps of:

in application scenarios such as virtual reality data mapping, using the propagation method mentioned above to construct the network for the multi-center area scene of the BlockNet to ensure a high degree of restoration of the real space data and realize efficient update of the BlockNet data, which comprises specific steps of:

Step 5.1: when a data modification operation is triggered on the BlockNet, changing a data field of the block to be modified;

Step 5.2: traversing blocks pointed to by the block to be modified, and recalculating hash values corresponding to these blocks; and

Step 5.3: repeat the Step 5.2 until reaching an edge to end a recursive process.

Further, the spherical multi-source translation projection method is specifically as follows.

Earth geographic data is a typical application scenario of spatial data mapping model, and its application in virtual reality is also the most extensive. Conventionally, the BlockNet stores data on a two-dimensional plane. In fact, the earth is a spherical shape, which will inevitably be divided. Because the data security factor far away from the source block is lower, and even if we can select multiple source blocks, the source block will appear on the edge. In response to this problem, a spherical multi-source translation projection technology is designed. Based on this technology, the spherical surface is re-mapped in two dimensions to ensure that the safety factor of the BlockNet reaches the optimal value. The specific steps are as follows:

Step 6.1: selecting a random space position as a center point for geometric mapping from a sphere to a space;

Step 6.2: selecting several central areas according to the importance of spatial data;

Step 6.3: calculating spatial geometric centers of the central areas; and

Step 6.4: using the geometric center position obtained in the Step 6.3 as a center point to perform the geometric mapping from the sphere to the space again.

Compared with the prior art, the present invention has the advantages that:

Compared with conventional latitude and longitude geocoding and two-dimensional Hash geocoding, the present invention not only realizes the unique primary key block coding of spatial data and speeds up the indexing speed, but also retains the elevation information through multi-dimensional coding, enlarges the amount of information, and improves the space. Data utilization efficiency. In addition, the BlockNet proposed by the present invention breaks the bottleneck that conventional blockchain technology can only store linear data, improves the dimension of stored data, and broadens the application scenarios of blockchain technology. The proposed BlockNet information modification and update plan, while ensuring data security, it makes it possible to dynamically update data on the blockchain, and its application in spatial data greatly improves the security of data mapping and storage procedures. At the same time, this model is applied to the division index of geographic three-dimensional space, data utilization scene space and data storage network space, providing a multi-dimensional and reliable experimental environment that is highly fitted to the real layer for theoretical research based on the virtual layer.

### BRIEF DESCRIPTION OF THE DRAWINGS

FIG. 1 is a technical roadmap of an embodiment of the present invention;

FIG. 2 is a blockchain storage two-dimensional data structure diagram of the embodiment of the present invention;

FIG. 3 is a schematic diagram of a result of lateral stretching of a blockchain according to the embodiment of the present invention;

FIG. 4 is a schematic diagram of repeated updates caused by a two-way chain according to the embodiment of the present invention;

FIG. 5 is a schematic diagram of a BlockNet gene propagation mechanism according to the embodiment of the present invention;

FIG. 6 is a diagram of a gene propagation model of a multi-source BlockNet according to the embodiment of the present invention;

FIG. 7 is a schematic diagram of a quantity of rounds and a safety factor of gene propagation in a BlockNet according to the embodiment of the present invention;

FIG. 8 is a schematic diagram of radiation impact according to the embodiment of the present invention;

FIG. 9 is a diagram of a multi-source BlockNet model of a synchronization propagation mechanism according to the embodiment of the present invention;

FIG. 10 is a schematic diagram of modified BlockNet data according to the embodiment of the present invention;

FIG. 11 is a schematic diagram of a Hash geocoding division method according to the embodiment of the present invention;

FIG. 12 is a diagram of a result of the embodiment of the present invention before being translated and projected by a spherical multi-source; and

FIG. 13 is a result diagram of the embodiment of the present invention after a spherical multi-source translation projection.

### DETAILED DESCRIPTION OF THE PREFERRED EMBODIMENT

In order to make the objectives, technical solutions and advantages of the present invention clearer, the present invention will be further illustrated based on the drawings and embodiments.

The present invention is based on theoretical methods such as Hash geocoding, blockchain and virtual reality, and is oriented to the storage and mapping application requirements of full-space data security organization, through key technologies such as three-dimensional Hash geocoding, BlockNet gene propagation construction method and radiation cross impact research and explore the storage mapping model of blockchain security organization for spatial data. Finally, the research method of combining theoretical analysis and application requirements, algorithm design and system implementation is used to design and develop a prototype system, and verify the effectiveness of the security data storage mapping based on three-dimensional Hash geocoding at the city level and the molecular scale.

FIG. 1 shows the overall architecture flow of the research content of the present invention. The BlockNet technology research carried out is to carry out high-security organization storage mapping of spatial data.

(1) Design of Multi-Dimensional Multi-level 3D Hash Geocoding

The mainstream Hash geocoding is performed on a two-dimensional plane. The principle is to divide the plane into 16 blocks, and each block can be further divided to achieve multi-level division; the coding process is to divide the geographical reality space; the latitude and longitude is converted into a binary code and then cross-combined, and then every four digits are converted into a corresponding hexadecimal system; but its disadvantage is that it can only perform a single primary key index on the information of the two-dimensional plane, and cannot express the height or index of high-dimensional information. In the process of spatial data organization and mapping, especially in the process of virtual space construction, it is necessary to index multi-dimensional information, so height is also a main parameter. There are two solutions to add height to Hash geocoding:

1. In the cross combination, the longitude, latitude, and height are crossed at the same time, that is, three binary codes are used to replace the original two binary codes for cross combination. The first item of the latitude and height code is followed by the second item, and so on, to form a 3n-bit combination code, and then a group of 4 bits is converted to hexadecimal to form a three-dimensional Hash geocoding. However, due to the height insertion, the height information embedded in this method becomes the inevitable noise data during the calculation of the plane logical distance, and the logical distance between points with similar latitude and longitude is far away.

2. In addition to directly combining the longitude, latitude, and altitude codes, another way to achieve this is to first cross the n-digit longitude and latitude to form a 2n-digit binary code combination and perform hexadecimal conversion when performing the code cross-combination. After combining into a two-dimensional Hash geocoding, the height parameter is converted to hexadecimal and spliced in the back, as a suffix code and two-dimensional Hash geocoding to form a fixed-length code. Table 1 is a three-dimensional Hash geocoding with Laoshan as an example:

TABLE 1
3D Hash geocoding

| Base | Longitude | Dimension | height |
|---|---|---|---|
| Decimal | 120 | 36 | 1132 |
| Binary | 0111 1000 | 0010 0100 | Not calculated |

| | | |
|---|---|---|
| Cross combination | 0010 1110 1001 0000 | Not calculated |
| Hexadecimal | 2E90 | 0046C |

| | |
|---|---|
| Hash encoding | 2E90-0046C |

In the Table 1, both longitude and latitude take 8-bit binary, which is cross combined to form 16-bit binary code, and 4-bit two-dimensional hash geocode after hexadecimal conversion. Taking the earth as an example, since the thickness of the atmosphere is more than 1000 km and the maximum decimal number that can be represented by 5-digit hexadecimal is exactly 1048575, the 5-digit hexadecimal is used as the fixed length height code.

The logical distance judgment can be divided into two cases: when judging the plane logical distance, the plane hash geocode of two nodes is converted into binary for XOR to obtain the logical distance. When judging the three-dimensional logical distance, first XOR the plane distance through longitude and latitude coding, then XOR the height distance through height coding, and calculate the three-dimensional logical distance between the two regions through spatial geometric function.

(2) Multi-Dimensional Data Secure Storage Technology—BlockNet

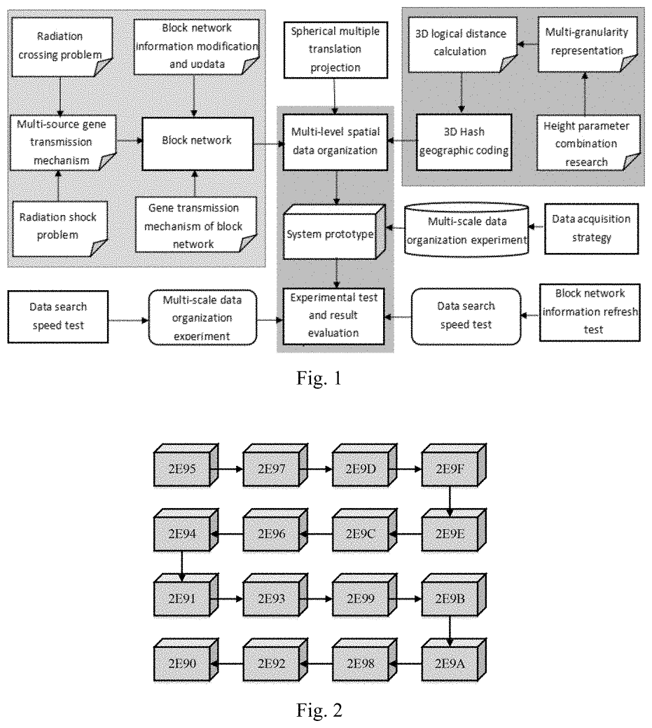

Realizing spatial data security organization mapping based on conventional blockchain technology is to organize and store the spatial geographic data divided by hash geocoding using blockchain. Each geographic data unit is represented as a connected block in the blockchain, and the data structure for storing geographic information is not one-dimensional linear, but mostly a two-dimensional table structure of quad-connecting or octa-connecting. If the geocodes are connected through the blockchain, that is, the tabular data is expressed in a chain structure. Conventionally, most schemes are to select a corner as the creation block and connect it in series along the “Z” shape in a certain direction. FIG. 2 is the current solution for using the blockchain to store two-dimensional data.

However, the blockchain is a one-way linear storage structure similar to the linked list. Its characteristic is that in the blocks on the chain, except the genesis block and the tail block, any other block only saves the hash value of its previous node, and its own hash value is saved in the next block, that is, the blockchain only records the sequential relationship of two adjacent nodes, regardless of the coordinate position of a block in the two-dimensional plane. Because of this property, using linear data structure to store multidimensional data will inevitably face the problem of relative position failure caused by chain structure stretching.

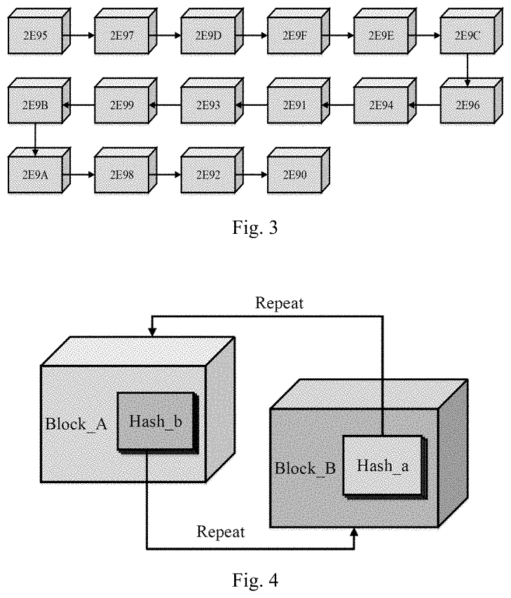

FIG. 3 shows the result of the horizontal stretching of the blockchain. The sequence of each block remains unchanged, but the relative position of most blocks in the two-dimensional plane has changed. Location information is not recorded in the blockchain, so the blockchain mechanism cannot detect this change. In the process of spatial data organization and mapping, spatial location is the most important data and the only primary key of information retrieval. This phenomenon is undoubtedly fatal. Therefore, the conventional blockchain is only suitable for secure and decentralized storage of one-dimensional linear data. Facing the requirements of two-dimensional data security storage mapping, it is necessary to design another data storage model.

To solve this problem, we propose a two-dimensional data-oriented block storage scheme—BlockNet: in the BlockNet storage model, there is not only a sequential connection relationship between blocks, which is different from the conventional blockchain that each node has only one in-degree and one out-degree. Each node in the

BlockNet has multiple in-degrees and multiple out-degrees. After the network widespread gene propagation, the generated BlockNet model will have strong robustness and tensile properties, so as to realize the characteristics of non-tensile and deformation of BlockNet. Next, gene propagation and other problems of block net will be described in detail.

(3) Construction of Gene Propagation Mechanism by BlockNet

The core method of data tamper proof by blockchain technology is: each block saves the hash value of its previous block data. If a block data changes, its adjacent blocks also need to be modified accordingly, then the cost of modifying a piece of data is to update all the data on the chain.

In this model, the initial construction scheme we designed is that each block saves the hash value of its quad-connecting block data, but this method has the problem of repeated updating. For example, block A saves the data hash value b of block B on its right, and block B saves the data hash value a of block A. However, after this operation, the data of block B changes, and b in block A needs to be updated. In addition, block B needs to update a, resulting in the emergence of dead cycle. FIG. 4 shows the repeated updating of data between adjacent blocks caused by the two-way chain mechanism.

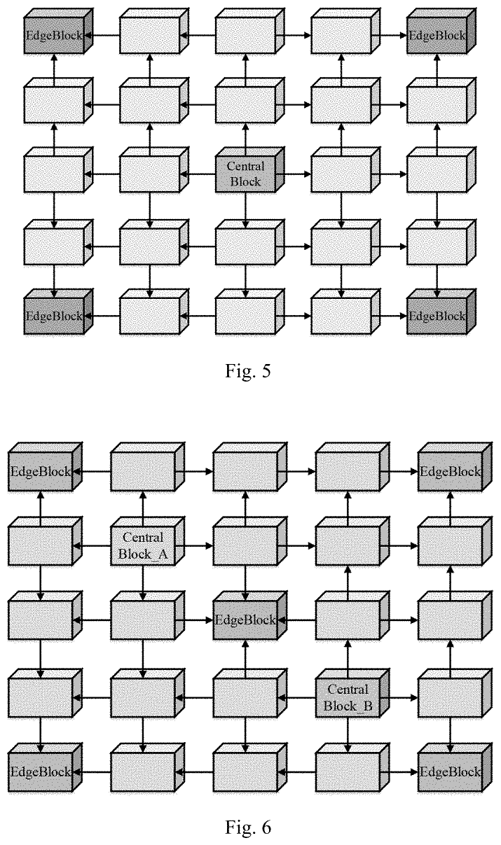

Therefore, we believe that in this model, the chain between blocks should be one-way, which requires us to find a block as the starting block for spreading gene propagation (because the next block stores the current block data, and we compare this to genetic inheritance). The first block that starts to spread is called the source block. We used the central block as the source block for testing, and finally designed the first-generation propagation rule of the BlockNet, that is, each block spreads in the opposite direction relative to the source block. According to this rule, BlockNet propagation can realize the spreading spread of two-dimensional data across the network. FIG. 5 is the gene propagation mechanism of the blockchain network.

By observing the constructed model, we find that the average in-degree and out-degree of each block are 2. Because the data of each block is added to its subsequent blocks after hash coding, the blocks with higher out-degree are less likely to be tampered with, and the blocks farther away from the central block are less expensive to tamper with data. We can observe that there are two special blocks: the source block in the middle of the BlockNet and the edge block at the four top corners. The source block is the creation block, with no in-degree and out-degree of 4, which is the most secure block in the whole network. The edge block has only in-degree and no out-degree. It is the most easily tampered block, and the tampering difficulty is almost 0.

In order to ensure the security of edge block data, we package the data hash values of edge blocks and save them in a separate block for other blocks to supervise.

BlockNet is designed for the secure storage of multi-dimensional data. Taking flat data as an example, it is essentially a two-dimensional table-like database realized by pointers, so we design based on the table data structure. Each block is mapped to a pair of row and column indexes in the block object table. In addition to storing the necessary data information, the block must also contain four Boolean status flags: upStatus, downStatus, leftStatus, and rightStatus, which are used to indicate the current in and out status of the quad-connecting area of the block, 0 means in-degree, 1 means out-degree; and there are four pointers: upNode, downNode, leftNode, and rightNode, pointing to the block location of its quad-connecting neighborhood. In addition, in order to realize the genetic process mentioned above, each block maintains a hash list with a maximum of 4, in which the hash value of the parent node is stored in the order of up, down, left, and right. So the data structure of each block is shown in Table 2:

TABLE 2
Block data structure
Block

| Obj | Data |
|---|---|
| Bool | upStatus, downStatus, leftStatus, rightStatus |
| Node | upNode, downNode, leftNode, rightNode |
| SHA256 | ParentHash[4] |

When performing BlockNet gene propagation, first select one or more source blocks through subjective judgment or weight calculation according to the importance of the data, and use Hash geocoding to map the spatial data storage value data field of the block. The four directions of the source area block are all out-degrees, so xStaus is all 1, and the size of the ParentHash list is 0, and then the four child node positions in the quad direction are calculated according to the row and column index of the block in the two-dimensional array, and stored into xNode. When constructing subsequent nodes, first set the xStatus status of the corresponding direction of the parent node to 0, and set the other directions to 1, and then use the SHA256 algorithm to calculate the Hash code and store it in ParentHash according to the block information stored in the secondary node in order.

At this time, the size of the ParentHash list is the number of parent nodes of the block; finally, the same calculation of the row and column positions of the quad-connecting area is stored in xNode. The above process is repeated until the BlockNet is built.

(4) BlockNet Gene Propagation and Radiation Crossover Problem

In this model, the farther the block from the source block is, the lower the security. In the process of data organization and mapping from the real world to the virtual world, there is more than one hot zone that needs to be described. If only one is selected in the BlockNet for the source block, there is a high probability that a more important location will appear on the edge block. For example, Beijing and Washington on the earth are far away but require high data security.

To solve this problem, we select multiple blocks as source blocks to propagate at the same time, and there will be repeated updates at the common edge blocks of multiple source blocks. We call this radiation crossover. In order to prevent the radiation flow of two source blocks from crossing, in the propagation process, if the target propagation block has an output to the current block, stop the propagation, and after the propagation, store the node information with an output of 0 into the edge node information block.

FIG. 6 is a multi-source BlockNet gene propagation model. The model selects two blocks as the source blocks. The numbers in the blocks indicate the quantity of propagation rounds and can also be regarded as the security level. It can be seen that the distance from the center block is farther while the security level of the far block is lower, this situation does exist in virtual reality application scenarios. It can be seen that it is feasible to implement priority secure storage for two-dimensional data based on this technology.

In order to achieve the above process, we only need to add a conditional judgment to the original propagation process, that is, the default value of the block's in and out status flag xStatus is 0, that is, first set the four directions of all nodes to the in-degree. Before constructing a certain node, first check the in and out-degree marks of neighboring nodes in the quad-connecting area corresponding to its own direction. If it is 0, it is considered that the node has not pointed to itself and can be regarded as the propagation target, and the xStatus of the corresponding direction is set to 1. Propagation in this direction is stopped avoid radiation crossing.

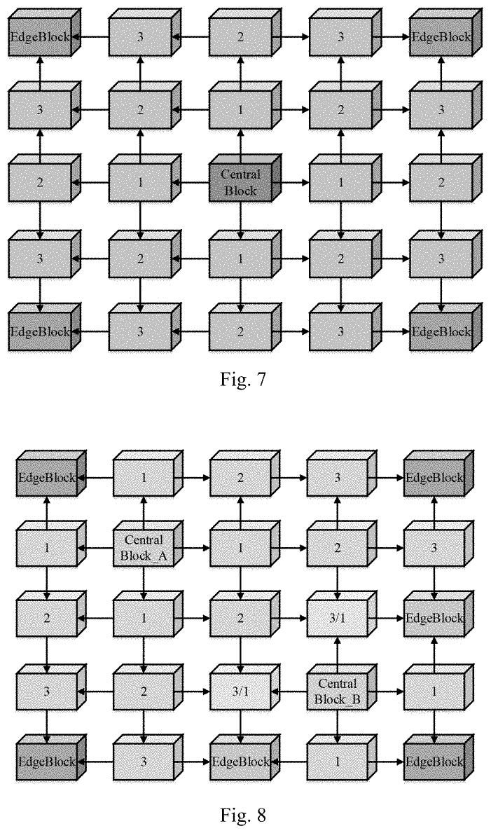

Since in this model, gene propagation starts from the source block and spreads out layer by layer, we can observe that the higher the quantity of propagation rounds, the lower the out-degree, and we discussed earlier that the lower out-degree, the easier it is to tamper with, that is, the higher the quantity of propagation rounds, the lower the safety factor. After the BlockNet is constructed through the gene propagation algorithm, the safety factor can be calculated by counting the quantity of propagation rounds to evaluate the security of the BlockNet. FIG. 7 shows the relationship between the number of rounds of gene propagation in the BlockNet and the safety factor.

(5) BlockNet Gene Propagation Radiation Impact Problem

In the multi-source propagation scenario of the BlockNet, in order to prevent the radiation flow of the two sources from crossing, the propagation is stopped when the target propagation block has an out-of-degree of the current block. However, due to network delay or computer computing power, when the user's consensus on a certain source block is too fast, its propagation speed is too fast, and its propagation speed is greater than other blocks, resulting in a smaller spread area of other nodes in the BlockNet, resulting in the low overall safety factor of the BlockNet, and thus impacting other source blocks in the BlockNet. FIG. 8 shows the situation that the source block A with a faster propagation speed impacts the source block B with a slower propagation speed in the multi-source propagation scenario of the BlockNet.

In FIG. 8, the number in the block represents the quantity of propagation rounds. We can observe that because the propagation speed of source A is too fast, it impacts source B, causing source B to only propagate for two rounds. We call this phenomenon a radiation flow impact. We mentioned earlier that the higher the quantity of propagation rounds, the lower the safety factor. Due to the impact of radiation flow, the overall safety factor in this case is lower. To prevent this situation, we propose a synchronous propagation mechanism based on message broadcasting, that is, after ensuring that all nodes have completed one round of propagation, the next round of propagation is carried out. FIG. 9 is a multi-source BlockNet model that follows the synchronous propagation mechanism.

The BlockNet model we proposed supports two methods: centralized network construction and decentralized network construction. Centralized construction means that the process of building BlockNet data is directly carried out by network administrators. Decentralized network construction is to build a point-to-point decentralized network, where users independently complete information collection and reach consensus to build a BlockNet database. These two construction methods are suitable for different application scenarios and need to be selected according to specific applications. However, as mentioned above, whether it is a centralized network construction or a decentralized network construction, it is necessary to control the number of propagation rounds. The control amount Term of the quantity of propagation rounds is added to the program to control the propagation, which represents the current ongoing propagation round. Waves[][] is defined as a dynamically growing multidimensional array. Information of several blocks is stored in Waves[i], indicating the target block that needs to be propagated in the i-th round. For example, Waves[0] stores several source blocks, and Waves[1] stores the quad-connecting neighborhood blocks of the source block. When the quantity of propagation rounds Term is 1, schedule the blocks in Waves[1] to propagate, and put the out-degree node information of these blocks into Waves[2], repeat the above process until the network is constructed complete.

(6) BlockNet Data Modification and Update Scheme

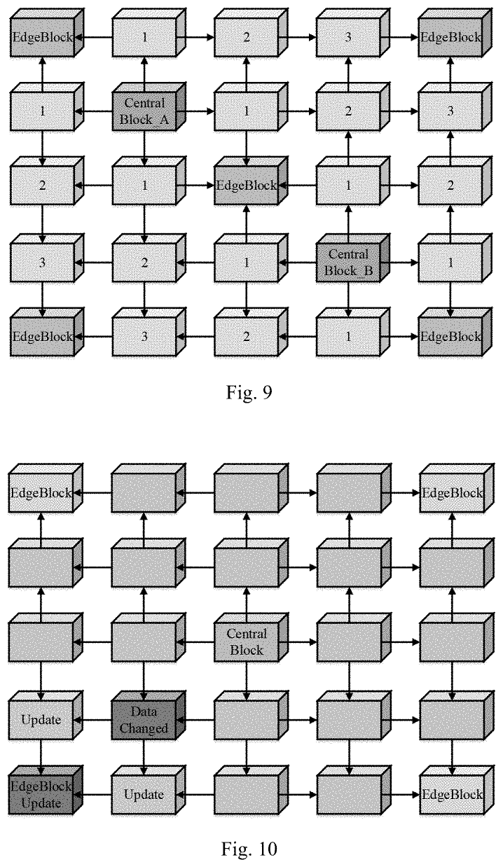

In order to achieve a high degree of restoration of real space data in the virtual reality space under the premise of ensuring safety, it is inevitable to update information on the BlockNet. Due to the decentralized nature of the blockchain, there is currently only one method for the blockchain to modify the data on the chain, that is, to master 51% of the computing power on the network. This situation is impossible to achieve in a sense. In the BlockNet model, it is allowed to modify the data of a certain block, and modifying the data of a certain block will not cause the data of the whole network to be refreshed. FIG. 10 shows the process of updating information on some BlockNet nodes after the data of a certain node on the BlockNet are modified.

In the lower left corner, there is a block whose data is modified, so only the block that has been propagated needs to update the data. In particular, if the source block is modified, then the entire network data may need to be refreshed (which depends on whether there are other source blocks).

When the information of a block needs to be modified, the centralized network administrator or the data modification initiator in the decentralized network will call the DataChange method to modify the Data field on the target block, and then traverse the xStatus in the quad-connecting area to find out the out-degree block. For the xNode corresponding to the out-degree block, the Update method is called. These blocks will recalculate the hash value of the parent node and immediately modify the corresponding data in ParentHash, and then repeat the above process until they reach the edge block EdgeBlock, which completes a BlockNet data update.

In summary, the algorithm of the BlockNet database construction process is described as follows. The Waves represents the set of blocks that need to be propagated in each round of propagation, Term represents the propagation round, I and J represent their row and column indexes in the two-dimensional table, map represents the location information of the block under the row and column index structure, DIRECTIONS represents the direction constant of the quad-connecting area, xNode and xStatus respectively represent the pointing node and pointing status of the corresponding direction, and ParentHash represents the result set after SHA256 settlement of the parent node:

Algorithm 1 BlockSpreading

```
Input: Term
Output: bool
FOR each in Waves[Term]:
  curI = each.I
  curJ = each.J
  each.upNode = map [curI − 1][curJ]
  each.downNode = map[curI + 1][curJ]
  each.leftNode = map[curI][curJ − 1]
  each.rightNode = map[curI][curJ + 1]
  FOR x in DIRECTIONS:
    IF each.xNode.-xStatus == 1:
      each.xStatus = 0
      ParentHash.add(SHA256(each.xNode))
    END IF
    ELSE:
      each.xStatus = 1
      Waves[Term + 1].add(each.xNode)
    END ELSE
  END FOR
END FOR
BlockSpreading(Term + 1)
```

The algorithm of the data modification and update process is described as follows. The Data represents the spatial data information stored in each block, and count represents the sequence number of the parent block where the information update of the current block occurs:

| Algorithm 2 DataChange | |
|---|---|
| | Input: node, data |
| | Output: bool |
| | node.Data = data |
| | FOR x in DIRECTIONS: |
| | IF node.xStatus == 1: |
| | Update(node, node.xNode) |
| | END IF |
| | END FOR |
| Algorithm 3 Update | |
| | Input: parent, node |
| | Output: bool |
| | count = 0 |
| | FOR x in DIRECTIONS: |
| | IF node.xStatus == 0: |
| | count = count + 1 |
| | IF node.xNode == parent: |
| | BREAK |
| | END IF |
| | END IF |
| | END FOR |
| | ParentHash[count] = SHA256(parent) |
| | FOR x in DIRECTIONS: |
| | IF node.xStatus == 1: |
| | Update(node, xNode) |
| | END IF |
| | END FOR |

(7) Multi-Level Spatial Data Organization

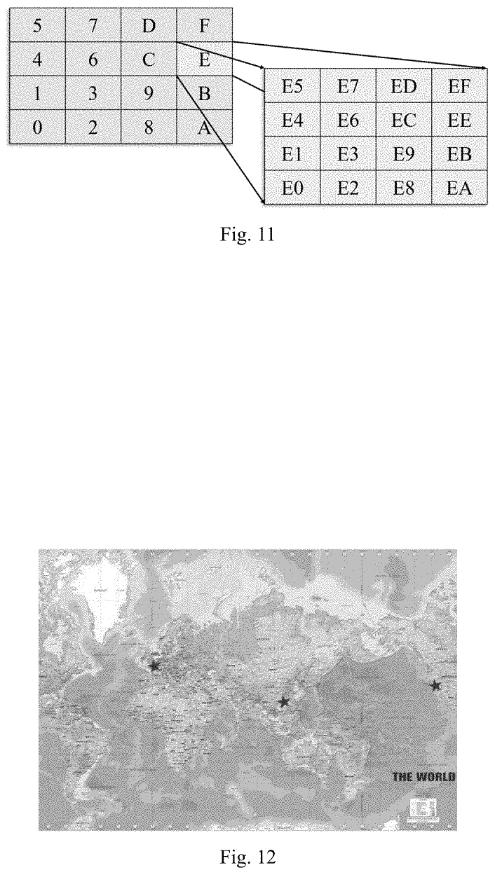

In order to realize the organization and mapping of full spatial data, it is necessary to organize and store fine-grained data by BlockNet combined with Hash geographic coding. In Hash geographic coding, the encoding of geographic information is multi-level. For example, we can divide geographic information into 16 blocks with 1-bit 16-digit number, and divide geographic information into 256 blocks with 2-bit 16-digit number. FIG. 11 illustrates dividing of Hash geographic coding.

From FIG. 11, we can see that the number of each block in Hash geographic coding increases by 16 times, and the area of the earth is about 510 million square kilometers. The accuracy of using Hash geographic coding to divide 10 times (i.e. 10-bit Hash geographic coding) can reach 0.463 m, which means that we have 10 layers of blocks from coarse to fine. If BlockNet technology is applied to each layer, it will take a lot of time to construct BlockNet. If only BlockNet is applied to the bottom layer, it can save resources and ensure data security. Table 3 is the relationship between Hash geographic coding bits, number of block and accuracy.

TABLE 3
coding bits, number of block and accuracy

| Hash geographic | Number of | |
|---|---|---|
| coding bits | bottom blocks | accuracy |
| 1 | 16 | 31875000000.0 |
| 2 | 256 | 1992187500.0 |
| 3 | 4096 | 124511718.75 |
| 4 | 65536 | 7781982.421875 |
| 5 | 1048576 | 486373.9013671875 |
| 6 | 16777216 | 30398.36883544922 |
| 7 | 268435456 | 1899.8980522155762 |
| 8 | 4294967296 | 118.74362826347351 |
| 9 | 68719476736 | 7.421476766467094 |
| 10 | 1099511627776 | 0.4638422979041934 |

(8) Spherical multi-source translation projection

The earth geographic data is a typical application scenario of Hash geographic coding combined with virtual reality technology. Conventionally, the BlockNet is a technology for storing data on a two-dimensional plane. In fact, the earth is spherical, which will inevitably be segmented. Because the data safety factor far from the source block is lower, and even if we can choose multiple source blocks, the active block may appear on the edge. FIG. 12 shows the multi-source data organization mapping of the

BlockNet on the earth before using the spherical multi-source translation projection technology.

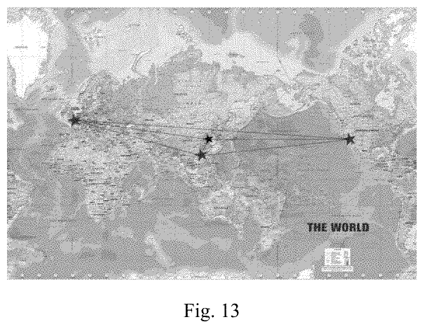

In FIG. 12, we selected three source blocks, designed the spherical multi-source translation projection, and selected the relative center point of all sources as the center point for translation projection. FIG. 13 is the result of the spherical multi-source translation projection, and the safety factor of the BlockNet constructed on this basis is increased significantly.

Those skilled in the field will realize that the embodiment described here is to help readers understand the implementation of the present invention, which should be understood as that the protection scope of the present invention is not limited to such special statements and implementation cases. Ordinary technicians in this field can make various other specific deformations and combinations that are not divorced from the essence of the present invention according to the technical enlightenment disclosed by the present invention, which are still within the protection scope of the present invention.

What is claimed is:

1. A BlockNet security organization storage mapping method for spatial data, comprising steps of:
building a BlockNet gene propagation mechanism based on characteristics of BlockNet storage space data firstly, and then designing a multi-source gene propagation mechanism for multi-space data center scenarios; wherein in the multi-source gene propagation mechanism, propagation round number control and in-out-degree control mechanisms are designed for a possible radiation cross problem and a radiation impact problem; designing a BlockNet information update scheme for data modification and update requirements in spatial data storage scenarios, and providing data retrieval methods from two perspectives of chain search and row-column index for spatial data utilization scenarios;
wherein for the partition index of three-dimensional spatial data, elevation data is added on a basis of original two-dimensional Hash geographic coding, and a data index conversion suitable for multi-level division is performed; when using a three-dimensional logic distance calculation algorithm to judge a three-dimensional logic distance, latitude and longitude codes and elevation codes of two target blocks are carried out XOR operations, and then results of the two XOR operations are calculated by an Euclidean distance to obtain the three-dimensional logical distance;
wherein in view of a multi-center situation occurring in a process of mapping spherical data to three-dimensional data, a spherical multi-source translation projection method is used to first map the spherical data to a three-dimensional space with a random starting point, find a spatial geometric center of a multi-target point, and perform a three-dimensional data translation conversion, in such a manner that a three-dimensional spatial data center is aligned with the spatial geometric center.

2. The BlockNet security organization storage mapping method for the spatial data, as recited in claim 1, wherein: the BlockNet gene propagation mechanism is constructed according to the characteristics of the BlockNet storage space data, which comprises specific steps of:
Step 1.1: selecting a starting node of BlockNet construction according to importance of the spatial data; and
Step 1.2: performing Hash coding propagation on quad-connecting regional nodes, wherein a next node calculates a hash value of nodes pointing thereto by SHA256;
in application scenarios of virtual reality comprise specific steps of:
Step 2.1: performing multi-scale partition coding of scene data based on 3D Hash geographic coding;
Step 2.2: selecting a center point according to a key area in the spatial data; and
Step 2.3: using spherical translation projection to translate a spatial position, and starting BlockNet storage construction from the selected center point;
wherein after a BlockNet is constructed, a safety factor is calculated according to a quantity of propagation rounds of each node, so as to evaluate overall safety of a model.

3. The BlockNet security organization storage mapping method for the spatial data, as recited in claim 1, wherein: in the multi-source gene propagation mechanism, designing the propagation round control and the in-out-degree control mechanism for the possible radiation crossover problem and the radiation impact problem comprises specific steps of:
performing control of a quantity of propagation rounds: when there are multiple central points which need important description in a space scene, multiple source blocks are selected for propagation, and the quantity of the propagation rounds is used to control a propagation speed of each of the source blocks to keep the source blocks synchronized, wherein in an area during the construction of a BlockNet, there is a global variable which controls the quantity of the propagation rounds; the global variable is compared during each round of propagation, and a block number belongs to the round before the propagation continues; similarly, by counting the quantity of the propagation rounds to which each block belongs, a global safety factor of the BlockNet is calculated.
the in-out-degree control mechanism comprises steps of:
Step 3.1: for all blocks, initializing in/out-degree status flags of a quad-connecting neighborhood to an in-degree;
Step 3.2: when a block triggers a propagation operation, checking an in/out-degree status of a quad-connecting neighboring block, if the out-degree is detected, executing a Step 3.3, otherwise executing a Step 3.4;
Step 3.3: stopping propagating in a detected direction, and setting an in/out-degree state tag of a corresponding direction as an in-degree; and
Step 3.4: Mark the in/out-degree state of the corresponding direction as the out-degree, putting a corresponding direction node into a next round of a propagation list, and executing the Step 3.2.

4. The BlockNet security organization storage mapping method for the spatial data, as recited in claim 1, wherein: for spatial data utilization scenarios, providing the data retrieval methods from the two perspectives: the chain search and the row-column indexing, comprises specific steps of:
Step 4.1: for a data demand node, broadcasting a row-column index corresponding to a current scene position to neighboring nodes;
Step 4.2: for adjacent nodes, finding a BlockNet location of a current scene resource by the row-column index;
Step 4.3: traversing quad direction nodes in block information of the current location, getting and loading data of the quad direction nodes, so as to realize the chain search; and
Step 4.4: sending corresponding scene resources to the data demand node.

5. The BlockNet security organization storage mapping method for the spatial data, as recited in claim 1, wherein: a 3D Hash geographic design of the three-dimensional logical distance calculation algorithm is specifically as follows:
in view of shortcomings of conventional Hash geographic coding technology in organization of multi-dimensional geographic information, starting from needs of spatial data collection and sorting, division characteristics of the spatial data are analyzed in depth; by comparing and analyzing advantages and disadvantages of spatial information data and Hash geographic coding, a three-dimensional space comprising longitude, latitude, and height is divided and a data model is constructed to realize the spatial data;
the spatial data is divided into a multi-layer hexadecimal tree according to a longitude and latitude observation plane, and a corresponding code is added to each node at each layer, until a leaf node is divided into a smallest unit of granularity representing the spatial data, wherein a full hexadecimal index tree of the spatial data is constructed, and each leaf node represents a smallest latitude and longitude observation plane; a division unit stores different levels of elevation information in a vertical direction, and then three-digit hexadecimal encoding is performed on the elevation information to generate vertical codes and latitude and longitude codes to form a three-dimensional Hash geographic coding; wherein a space division method realizes unlimited gradient division from macro to micro, so as to be more suitable for multi-dimensional and multi-level spatial data storage in blocks, and explore a logical distance judgment method based on the 3D Hash geographic coding; when judging a 3D spatial distance, first different prefix latitude and longitude codes of two 3D Hash geographic coding are performed or a plane distance is calculated, and then XOR of a suffix elevation code is performed to get the vertical distance, and finally a spatial Euclidean distance is calculated by calculating the plane distance and the vertical distance.

6. The BlockNet security organization storage mapping method for the spatial data, as recited in claim 1, wherein: a modification and update method of BlockNet data comprises specific steps of:
Step 5.1: when a data modification operation is triggered on a BlockNet, changing a data field of the block to be modified;
Step 5.2: traversing blocks which the block to be modified points to, and recalculating hash values corresponding to the blocks; and
Step 5.3: repeating the Step 5.2 until an edge is reached to end a recursive process.

7. The BlockNet security organization storage mapping method for the spatial data, as recited in claim 1, wherein: the spherical multi-source translation projection method comprises specific steps of:
Step 6.1: selecting a random space position as a center point for geometric mapping from a sphere to a space;
Step 6.2: selecting several central areas according to importance of the spatial data;
Step 6.3: calculating spatial geometric centers of the central areas; and
Step 6.4: using the geometric center position obtained in the Step 6.3 as a center point to perform the geometric mapping from the sphere to the space again.
